(19) United States
(12) Patent Application Publication
(10) Pub. No.: US 2021/0375129 A1
(43) Pub. Date: Dec. 2, 2021

(54) Traffic Signal Pan-String Control Method and Its System

(71) Applicant: Weiping Meng, Flushing, NY (US)

(72) Inventor: Weiping Meng, Flushing, NY (US)

(21) Appl. No.: 16/649,652

(22) PCT Filed: Sep. 18, 2018
(86) PCT No.: PCT/CN2018/000332

§ 371 Date: Mar. 22, 2020

(30) Foreign Application Priority Data
Sep. 28, 2017 (CN) 201710897777.6

(51) Int. Cl. G08G 1/083; G08G 1/08; G08G 1/065; G08G 1/01; G06N 3/04

(52) U.S. Cl. CPC G08G 1/083; G08G 1/08; G06N 3/04; G08G 1/0145; G08G 1/065

(57) ABSTRACT

The invention relates to a traffic signal control field, discloses method and system of dynamic adjust signal time according to traffic flows in order to decrease stops/starts and green-light idle time: method includes: 1) get parameters of roadnet, signals; 2) get traffic flows; 3) I-neurons predict traffic flows about over thresholds; 4) P-neuron determine pre-judges according to over thresholds of intersection; 5) overall trade-off accept/reject, priority, schedule, and management of pre-judges, make and send I-instructions; system includes: 1) predict method package; 2) traffic data center or vehicle queue detecting equipments; 3) or vehicle in/out detectors; 4) traffic signals controllers. The predicting math model based signals net universal “A-A” serial method, support String mode control, enable roadnet traffic always run low energy consumption signals, avoid redundant stops/starts one time per period per vehicle per road-segment about 60 seconds and idle gasoline consumption, 30 vehicles about 30 minutes idle gasoline consumption per road-segment, and with solitary wave technique for dissolving jam-core, suddenly-happened big queue, provide a serial continuity solution means for signal control to dissolve congestion core, early congestion, delay arrival of a large cluster of congestion, improve efficiency of traffic signal response.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to a method for traffic control, particularly to traffic signal control method that dynamically adjust signal time in terms of traffic.

Metropolitan traffic signals control methods including area-control currently mainly rely on artery-coordination control technology, which as the results of the interactions of city's evolution and technology's development at present is increasingly restricting urban development. Artery-type green-waves enables “vehicles follows the green wave going to the unlimited end of this waves”, which solved the RATIO mode's problem that a green light permits vehicles to move at most such a distance that is set-drive-speed multiplied by the time of the green light; however, its uni-directional effectiveness suppresses traffic requirement at its cross direction, its non-dynamically optimization leads waste of lots of green-light time, what's more remarkable is that the artery-type green-waves technique that was designed for improving traffic effective in artery-roads currently turns out an important cause of traffic jam in wider and wider green-wave artery roads and idle in non-artery roads because traffic in streets around those arteries gather at those arteries road for green-wave speed; the advantages of the artery green-wave technique that was created for street/traffic-features of middle or small size cities has already faded into a vicious cycle of “widening the main road and causing more congestion”, which is inherently unadaptable for the larger and larger area traffic demand of modern urban scale economy. The recently invented Time-differential ratio technology solves the problem of waste of small traffic wide-spectrum load green light idle in all directions in the whole network; String mode solves the problem of equilibrium and fast in all directions in the whole network; Pan green-wave's “no redundancy TRQ=0” law and its operation principle reduces the waste of traffic to the minimum. String mode needs to solve the problem of response to the traffic flow distribution in the region to further improve the actual control effect of string technology. Traffic flow prediction is the key of signal dynamic control. At present, neural network, chaotic time series, wavelet and other methods are mostly studied.

### BRIEF SUMMARY OF THE INVENTION

The purpose of the invention is to solve the problem of low consumption optimization of signal response to traffic flow distribution.

The present invention provides a solution to achieve the above object, including new invented Signals'-Distance-and-Queue-Redundance-formula-trq-based mathematical model of road network traffic prediction, and based-on-the-model's analytical-artificial intelligent predict control A-A method, integrated and expanded the “no redundancy law TRQ=0” and the operation principle of pan green-wave judgment, designed the “solitary wave” algorithm, integrate out a system method that applies the Model to String mode, obtains the pluck-able string; so named as Pan-string. The features are as follow:

A traffic signal Pan-String control method, also named as A-A method, includes steps \textcircled{1}:

S1: obtain signal parameters and its roadnet's parameters;

S2: detect in every direction d of all intersections queues Q, numbers of waiting vehicles, or/and numbers s of vehicles in and out from vehicles' sources of same vehicle motion direction road-segment, amounts of vehicles in and out, or including numbers x of vehicles leaving the road-segment, outflow x, or/and queue-head's position q0 and phase-change differential-time [symbol] t^{Th0};

S3: predict queue Q and its change [symbol] Q, outflow x and remaining green signal time, remaining-phase-time, \tilde{τ}, in direction and phase in next time interval, with intersection-neuron, I-neuron, of predict layer;

S4: pre-judge signal parameter optimization, fluctuations of signal time-offsets between intersections, or/and shift of source intersection, shift-of-origin, of a green-wave due to traffic change in two cross directions in a roadnet, or/and solitary wave for said Q and [symbol] Q according to budgeting signal time combining remaining phase times τ(c) of relevant intersections and direction, or/and artery-fluctuations or -solitary wave, or/and 2 dimensional traffic flows' mode change, or/and differentiable intersection with no vehicles in a phase, or/and roadnet signal ratio change, in next time interval, with pre-judge-neuron, P-neuron, in analysis layer;

S5: overall trade-off pre-judges: accept or reject, priority, schedule, make and send out I-instructions for signal-parameter-adjust, directly go to S7 for intersections with no ratio phase vehicle and instruction, with decision layer;

S6: adjust signal time according to I-instruction: (1) intersections with over-thresholds adjust time-offsets: 1) configuring interim-periods of fluctuation state-change codes and its time-offsets tgw for intersections of fluctuation related road-segment and downstream intersections, 2) making and sending solitary wave order-codes that include scheme of times of every direction and phase of solitary wave source intersection and its downstream intersections, 3) configuring interim-period of said shift-of-origin, (2) other intersections with lower-thresholds carry out S7;

S7: execute: (1) interim-period: run new period after an intersection runs out its interim-period of a mode or/and its temporary time-table or/and (2) differential control: intersections equipped with differential sensors, D-sensors, of vehicles or by differential instruction: analyze queue-head q0's positions of every phase of an intersection, decide when to do differential green-wave (or called phase-change quantum/differential) control: assign a phase-change differential time (quantum-time) [symbol] t^{Th0} of a current ratio phase green light time with no vehicle q0 within pre-determined safe distance for a vehicle to brake at an intersection to a phase with vehicle q0 and banning re-differential; non-differential state of an intersection go back to S3;

Said queue Q of vehicles is measured in meter or vehicles, which length means queue length of a queue about the number of standard vehicle includes the distance between two adjacent vehicles which can be converted in meter-measurement of a vehicle queue;

Said vehicles means the vehicles converted into standard vehicles;

Said next time interval refers to signal period C and its multiple 1C, 2C, 4C, 8C, can be used in any signal network to predict queue Q of vehicles.

Another feature of the present invention is that the step S2 includes steps of:

S2-1 said queue-tail q means phase last vehicle's position and its distance from its heading intersection, standing for a vehicles' queue's length, said queue-head q0 means phase most front vehicle's position and its distance from its heading intersection, said q may be obtained from real time traffic meter-precision positioning data, such as a vehicle positioning device or a mobile phone positioning plug-in, or a common traffic sensing device, such as video, microwave radar, etc., that can measure last car in real time, said head information can be obtained by using a real-time traffic video analysis device or microwave, large data, and any device that can detect first car in real time.

Another feature of the present invention is that step S2 includes steps of:

S2-2 said phase-change quantum-time [symbol] t is the least safe response time of time-differential ratio, said minimum safe permit response time is suggested less than or equals to 6 sec that is obtained at city speed 60 km/h, its corresponding queue head q0 ranges 40 meter-60 meter, or obtained from direct computation on set-drive-speed of controlled road-segments.

Another feature of the present invention is that step S3 includes steps of:

S3-1 Said predicting queue Q and its change [symbol] Q include: (1) add detected vehicles ä entering a road-segment in direction d from its immediately upstream intersection or/and take the sum of vehicles out x_{±1,d1,j1}(c), x_{±1,d2,2j}(c), x_{±1,d3,j3}(c) from upstream intersection phases, and vehicles out s in the d direction from traffic source S_{d}(c) in the road-segment merging into the d direction, obtain predicted vehicles arrival a_{±0,d} of an intersection-direction d, (2) then by multiplying phase-vehicle-distribution coefficient μ_{d}(c) of the intersection-direction obtain predicted phase vehicles arrival a_{d,j}(c) of the intersection-direction, (3) then by decreasing phase vehicles out x_{±0,d,j} from the predicted phase vehicles arrival a_{d,j}(c), obtain a predicted phase change [symbol] Q of queue Q, (4) then by adding the predicted phase change [symbol] Q to queue Q_{d,j}(c−1) in last time interval, obtain a predicted phase vehicle queue Q_{d}(c);

Said ±k,d,j of x_{±0,d,j}, as subscripts, in the order of their positions, ±stand for the intersection of the k-th road-segment in upstream, d for traffic heading direction, j for signal phase, k=0 for a local intersection, k=1 for an adjacent intersection, k=2 for a 2nd adjacent intersection, and so on; for a local intersection, its subscripts variables may be for short q_{d,j}(c) or q_{d}(c) or q_{±0}(c) or q_{m,n,d,j}(c) with ±k omitting, ‘m,n’ for an intersection's coordinates,

Said traffic source S_{d}(c) is predicted by a traffic source AI function Ŝ(c) based on data S_{d}(c-1) detected or predicted in last time interval; the traffic source AI function Ŝ(c) is obtained by an AI learning method trained with data past or on-line;

Said phase vehicles, for sharing lane of multi-phases, is determined still by phase-traffic-distribution-coefficient μ_{d}(c)_{;}

Said traffic source of a road-segment including multi-traffic sources in a road-segment direction have their time-offsets to their downstream intersection determined by their average distance to the intersection, usually taking their average time-offset or with 0 time-offset;

Said AI learning method includes Artificial Neuron Networks ANN, Chaos Time Series, Wavelet theory, Statistical Regression and Support Vector Machine SVM, Genetic Optimization GA, Particle Swarm Optimization PSO, Fuzzy Analysis and Information Granulation, and their Comprehensive use, hereinafter the intelligent methods mentioned as same as the above;

Said phase vehicles out x_{±0,d,j}(c), x_{±1,d1,j1}(c), x_{±1,d2,j2}(c), x_{±1,d3,j3}(c) of a direction are obtained by the following method predicting or with equipped phase-vehicle-out detectors detecting.

Another feature of the present invention is that step S3-1 includes steps of:

S3-1-1 phase-vehicles-distribution coefficient μ_{d}(c) is predicted with phase-vehicles-distribution AI function \hat{μ}_{d}(c) and last time interval's predicted values μ_{d}(c−1);

Said predicted values μ_{d,}(c−1) is computed out based on detect in steps: (1) obtain [symbol] Q_{d,j}(c−1) by subtracting detected phase vehicles' queues in the previous two corresponding time intervals, (2) obtain phase vehicles out x_{d,j}(c−1) by phase green time τ_{d,j} multiplying phase vehicles' rate out ν_{d,j}; when traffic is light, use predicted phase vehicles out in previous time interval as “current detected” phase vehicles out, or/and directly use detected phase vehicles out, (3) obtain phase arrival vehicle a_{d,j}(c−1) by adding obtained [symbol] Q_{d,j}(c−1) and x_{d,j}(c−1), (4) obtain a phase-vehicles-distribution μ_{d,j}(c-1) by the a_{d,j}(c−1)s' being divided by the sum of the three a_{d,j}(c−1) vehicles;

Said phase vehicles' out rate ν_{d,j} means vehicles leaving intersection-stop-line per second; Said phase-vehicles-distribution AI function μ_{d}(c) is an intersection-direction-phase vehicles time distribution obtained by Artificial Intelligence method trained with the past traffic data.

Another feature of the present invention is that step S3-1 includes steps of:

S3-1-2 phase vehicles out x_{d,j}(c) are vehicles predicted that are from local queues, upstream intersections' vehicles out x_{±k,d,j}(c), and upstream road-segments' traffic sources s_{±k,d,j}(c), that their needed intersections' pass time and road-segments' travel time are local intersection phase green light time by computing remaining-phase-time τ_{±k,d,j}(c), k=0, 1, 2, . . . , for remaining-phase-time τ_{±k,d,j}(c)>=0 for its queue Q_{±k,d,j}(c−1), x_{±k,d,j}(c) is taken into account; and for remaining-phase-time τ_{±k,d,j}(c)<0 for its queue Q_{±k,d,j}(c−1), x_{±k,d,j}(c) is taken into account according to τ_{+k,d,} divided by phase vehicles rate out ν_{±k,d,j}; the predicted vehicles out x_{±k,d,j}(c) is computed based on the detected vehicles queue q_{±k,d,j}(c−1), k=0, 1, 2, . . . .

Said remaining phase time function τ_{d,j}(c) is predicted with the following claimed method; or/and is detected and computed with detectors for vehicles out x_{d,j}(c).

another feature of the present invention is that step S3-1 includes steps of:

S3-1-3 remaining phase time τ_{d,j}(c) is a predicting function that a phase time subtracts pass time predicted for current phase vehicles queues with existing queue-time-offset trq_{±k}(c) and the phase queue pass time tq0_{±k,d,j}(c) from a local intersection to its upstream intersections' queues q_{±k,d,j}(c) and including their road-segments' traffic sources s_{±k,d,j}(c), k=0, 1, 2, . . . , until the remaining phase time τ_{d,j}(c) becomes 0 or smaller;

Said phase queue pass time tq0_{d,j}(c) is obtained with queue Q divided by phase speed ν_{d,j};

Said queue-time-offset trq_{±(k-1)}(c) of upstream k-th (k>1) intersection's queue and its heading intersection's queues is obtained with set-drive-speed ν_{d,(k-1)} dividing the (k-1)-th road-segment length D_{±(k-1)}, then subtracting the product of queue q_{±(k-1)}(c) and queue-impaired factor β; for vehicles following green-wave motion with time-offsets |δc_{±i,dc}|>0, trq_{±(k-1)}(c)=β×q_{±(k-1)}(c)<0, and when queue q_{±(k-1)}(c) is small, trq_{±(k-1)}(δc_{±(k-1),dc}) is close to 0, for vehicles retrograding green-wave motion, its trq_{±(k-1)}(δC)=2×tν0_{±(k-1)}(0)−β×q_{±(k-1)}(c);

Said queue-impaired factor β=1/ν_{d,(k-1)}+α, is the sum of the reciprocal of set-drive-speed ν_{d,(k-1)} and queue-start coefficient α;

Said queue-start coefficient α means start-time per queue-meter, unit, second per meter, the estimated range from 0.14 to 0.22, take the median 0.18, adjusted according to empirical data;

Said time-offsets δc_{±i,dc} is the i-th road-segment divided by set-drive-speed ν_{d,(k-1)}, get tν0_{±i}.

Another feature of the present invention is that step S3-1 includes steps of:

S3-1-4 phase queue Q_{m,n,d,j}(c) and its change [symbol] Q_{m,n,d,j}(c) predicted by an intersection-neuron and found over the follow thresholds will be sent out for further analysis, the thresholds includes minimum queue-change-threshold [symbol] Q^{Th0}, state-threshold Q^{ThC}, minimum relative solitary wave queue-difference threshold [symbol] Q^{Th0}, minimum absolute solitary-wave queue-length threshold Q^{ThC},

Said minimum queue-change-threshold [symbol] Q^{Th0} means a designed minimum queue change during a time interval;

Said state-threshold Q^{ThC} is a queue length as the change point of two green-wave directions; Said minimum relative solitary wave queue-difference threshold [symbol] Q^{ThS} means a designed minimum queue length difference relative to other phase queues' lengths;

Said minimum absolute solitary-wave queue-length threshold Q^{ThS} means a designed minimum queue length for a solitary wave.

another feature of the present invention is that step S3-1 includes steps of:

S3-1-5 time before which traffic data are acquired by intersection-neurons of predict layer is next period start instant for non-green-wave and synchronous mode systems, or an intersection's next period start instant for green-wave mode systems.

another feature of the present invention is that step S3-1 includes steps of:

S3-1-6 intersections' index range K_{d} from which traffic data are acquired by an intersection-neuron of predict layer is the number of downstream intersections vehicles move and pass by during phase time τ_{d,j=1} green light time of local intersection of an intersection-neuron, is covered by sum of distances of K_{d} road-segments, each of which equals to τ*ν0, where τ is green-light time, ν0 is set-drive-speed, i.e.,

$$τ > {\sum }^{{K}_{d}} {D}_{\pm i} / v 0$$

for non-green-wave synchronous mode systems, or is all upstream intersections including source-intersection from local intersection for traffic following green-wave and downstream intersections for traffic retrograde green-wave covered by the sum of distances of K_{d} road-segments and their time-offsets δcᵢ, i.e.,

$$τ > {\sum }^{{K}_{d}} ( {D}_{\pm i} / v 0 + \vert δ {c}_{i} \vert ) ,$$

and where K_{d} does not cover last downstream road-segment but or covers its traffic source S for green-wave mode systems.

Another feature of the present invention is that step S4 includes steps of:

S4-1 pre-judges fluctuation of signal time-offsets by a pre-judge-neuron in analysis layer based on said Q and [symbol] Q exceeding thresholds [symbol] Q^{Th0}, Q^{ThC} received from intersection-neurons in corresponding row and column whether or not the number of the road-segments in the same row or column, and their downstream traffic direction as an intersection-neuron's intersection is in and concerns traffic direction exceeds rows threshold M^{Th0} or column threshold N^{Th0}, for yes, determines the fluctuation of signal time-offsets, for the shorter green-light time or overlong road-segment does not analyzes the row threshold M^{Th0} or column threshold N^{Th0} but analyzes independently the fluctuation of signal time-offsets for road-segments of intersection-neuron's intersection.

Another feature of the present invention is that step S4 includes steps of:

S4-2 pre-judge shift of origin by a pre-judge-neuron in analysis layer based on said Q and [symbol] Q exceeding thresholds [symbol] Q^{Th0}, Q^{ThC} of intersections in directions received from intersection-neurons of intersections: calculates total traffic volume or/and queue Q_{d}=ΣₘΣₙ q_{m,n,d}/n_{m,n,d} and its total change [symbol] Q_{d}=ΣₘΣₙ [symbol] q_{m,n,d}/n_{m,n,d} of every intersection in every direction din roadnet, for [symbol] Q_{d} bigger than [symbol] Q^{ThM}_{d}, with two bigger Q_{d} s, makes the reset time-offset table of shift of origin.

Another feature of the present invention is that step S4 includes steps of:

S4-3 pre-judge solitary wave by a pre-judge-neuron in analysis layer based on said Q and [symbol] Q exceeding thresholds [symbol] Q^{ThS}, Q^{ThS}: determines whether or not local intersection has remaining phase time \hat{τ} available for the over-thresholds Q and [symbol] Q, for yes, makes solitary wave.

Another feature of the present invention is that step S4-3 includes steps of:

S4-3-1 pre judge said solitary wave by: (1) pre-judge a solitary wave source: calculate remaining phase time \hat{τ}_{S} in every direction of local intersection on received queue Q and its changes [symbol] Q exceeding relative threshold [symbol] Q^{ThS} and absolute threshold Q^{ThS}, find a \hat{τ} long enough for Q^{S}=Q^{ThS} or shorten Q to pass and then configure a temporary timetable for a solitary wave source of the Q^{S} to pass, (2) pre Jude a solitary wave path: based on drive time from the solitary wave source to pass its downstream intersections, pre-judge remaining phase time \hat{τ} of downstream intersections, find these \hat{τ}_{S} long enough for Q^{S}=Q^{ThS} to pass, and then configure a temporary timetable for the solitary wave path of the Q^{S} to pass.

Another feature of the present invention is that step S5 includes steps of:

S5-1 overall trade-off rules about pre-judges as input data of decision layer includes: (1) collision-free rule among solitary wave: parallel or no cross point between solitary wave paths, (2) collision-free rule among solitary wave and fluctuation: whole solitary wave path is within upstream of fluctuation, (3) biggest solitary wave priority under collision among solitary waves, (4) solitary wave priority under collision between solitary wave and fluctuation, (5) solitary wave management: divide the intersections of a solitary wave path into groups, n^{LimS} intersections each group, make I-instructions that configure solitary wave path, SW-path-ban, re-SW-path, SW-time, and sends out the I-instructions.

Another feature of the present invention is that step S3-1 includes steps of:

S3-1-7 phase arrival vehicles a_{±0,d,j}(c) is obtained with got x_{±1,d1,1}(c), x_{±1,d2,2}(c), x_{±1,d3,3}(c), S_{d}(c), μ_{d}(c), and steps as follows:

1) by gathering 3 upstream phases-vehicles-distributions of local direction d intersection, straight-phase j₁ in the d, left-phase j₂ in direction d₂, right-phase j₃ in direction d₃, of upstream intersection and vehicle-sources ±S_{d}(c−1) of the upstream road-segment of a local intersection, obtain intersection direction arrival vehicles a_{d};

2) by multiplying μ_{±0,d,j}, obtain a_{d,j}×(x_{±1,d1,j1}+x_{±1,d2,j2}+x_{±1,d3,j3}±S_{±1,d}).

Another feature of the present invention is that step S3-1 includes steps of:

S3-1-1-1 said phases-vehicles-distribution AI function μ_{d}(c), with q_{m,n,d,j}(c) or its change [symbol] q_{m,n,d,j}(c), s_{m,n,d,j}(c) of an intersection and AI learning method, train the method and find a phase-vehicles distribution function μ_{d}(c) of an intersection direction, steps as below:

1) obtain phase queue change [symbol] Q_{d,j}(c−1) from periodically detected phase queue Q_{d,j}(c−1)−Q_{d,j}(c-2);

2) obtain phase vehicles out x_{d,j}(c−1) from phase green light time by the phase vehicle speed τ_{d,j}*ν_{d,j}, or from prior predicted phase out-vehicles x_{d,j}(c) under light traffic instead of detected phase out-vehicles x_{d,j}(c−1);

3) add the two results, get a phase arrival vehicles a_{d,j}(c−1)= [symbol] Q_{d,j}(c−1)+x_{d,j}(c−1);

4) add the three a_{d,j}(c−1), get direction arrival vehicles a_{d,j}(c−1)/a_{d}(c−1);

5) a_{d,j}(c−1) divided by a_{d}(c−1), get μ_{d,j}(c−1)=a_{d,j}(c−1)/a_{d}(c−1),

6) taking the got previous period μ_{d,j}(c−1) as this period three predicted values, with x_{±1,d,j=1}(c)+x_{±1,d2,j=2}(c)+x_{±1,d3,j=3}(c)±S_{±1,d}(c) of this period detected vehicles from related phases of upstream intersections and vehicle sources of upstream road-segment of this intersection, net-in/out-vehicle s_{d}(c) of this vehicle source, total 4 AI inputs, or vehicles-out and vehicles-entering s_{d,o}(c), s_{d,i}(c) of this vehicle source, total 5 AI inputs, as inputs data in a learning period, train an AI machine with AI learning method 2 such as RBF neural-networks running on periodical signals for certain time, saying 7 days or 30 days, 10080/minutes per learning period, obtain the AI function μ_{d}(c), and which is capable to learn on line.

Another feature of the present invention is that step S4 includes steps of:

S4-1-1 said pre-judge fluctuation as below,

1) obtain phases queue Q_{d,j}(c−1) and Q_{d,j}(c) of intersections (predict layer),

2) find out the intersections that queues change exceed fluctuation threshold [symbol] Q_{d,j}^{Th0} or state threshold [symbol] Q_{d,j}^{ThC} (predict layer), [symbol] Q_{d,j}^{Th0}=3 (vehicle length), rules for finding out the queues are that an average lane queue length Q_{d,j}(c)=Q_{d,j}(c)/n_{d,j}, where n_{d,j} is the number of lanes of phase j, of queue Q_{d,j}(c) is considered to exceed [symbol] Q_{d,j}^{Th0} when Q_{d,j}(c) is incremental, k* [symbol] Q_{d,j}^{Th0}/2<Q_{d,j}(c)<(k/2+1)× [symbol] Q_{d,j}^{Th0} where [symbol] Q_{d,j} is positive (k is odd) or Q_{d,j}(c) is decremental Q_{d,j}(c)>=(k/2+1)× [symbol] Q_{d,j}^{Th0} where [symbol] Q_{d,j} is negative,

3) find the row or the column of road-segments that includes the intersection's queue exceeding fluctuation threshold (analysis layer), row threshold N^{Th0}=N/2, column threshold M^{Th0}=M/2, M and N are total numbers of the rows and columns,

4) calculate an average queue time-offset tgw fluctuation of the above found road-segments of the row or column exceeding N^{Th0} or M^{Th0} (analysis layer),

5) fluctuation-pre-scheme, calculate an average fluctuation time-offset t⁻gw and the fluctuation time-offsets for the relative road-segments (analysis layer),

6) overall trade-off and coordinate (policy-decision layer), inspect and coordinate collision with other scheme, makes and sends out fluctuation instructions

7) decode and execute fluctuation/state-change (carry-out layer): according to instructions of fluctuation and state-change with fluctuation time-offsets tgw, configure interim periods, and send them to the intersections of fluctuation and their downstream intersections.

Another feature of the present invention is that step S3-1 includes steps of:

S3-1-8 said queue time-offset tgw fluctuation is [symbol] trq_{m,n,d}(δc_{dc}) from queue-time-offset trq_{m,n,d}(δc_{dc}), i.e. − [symbol] tqx(q)=−(1/ν0+a)* [symbol] q, instruction includes adjustment of queue time-offset tgw related to pan-string time-offset δc of intersections to offset the redundant from [symbol] q: take [symbol] tqx as tgw into the time-offset δc of downstream intersections, i.e. [symbol] trq= [symbol] tqx=tqx2−tqx1=−(1/ν0+a)* [symbol] q, [symbol] q=q2−q1, q1—pre-period queue length, q2—post-queue length.

Another feature of the present invention is that step S6 includes steps of:

S6-1 said adjust signal time includes queue time-offset tgw fluctuation, solitary wave scheme time-tb1, shift-of-origin time-offset o-tmd, etc, 1) for fluctuation, take tgw into the time-offset δc, i.e. configure queue time-offset tgw fluctuation into interim-periods for fluctuation intersection and their downstream intersections, 2) for solitary wave scheme time-tb1, according to the time-tb1 make and send solitary wave instruction codes that include phase scheme and time schedule to the solitary wave source intersection and its downstream intersections along solitary path, 3) for shift-of-origin time-offset o-tmd, with the o-tmd configure and send the interim period for every related intersections.

Another feature of the present invention is that step S7 includes steps of:

S7-1 said “assign a phase-change differential time (Quantum-Time) [symbol] t^{Th0} of a current ratio phase green light time with no vehicle q₀ within pre-determined safety braking distance of an intersection to other phase with vehicle q₀”, when there are multiple phases with detected vehicles coming the assignment is to follow a phase priority and scheme, or directly let the phase holding permit with a vehicle detected continue.

A traffic signal Pan-String control system, includes a running A-A method predicting and controlling software, named as A-A package, a vehicle-positioning data center, or/and vehicle queues and their staying number detector, traffic signal controller, or/and vehicle entrance-exit detector of road-side vehicle source, or vehicle exit detector of an intersection, or/and vehicle entrance detector of a road-segment,

said A-A package predicts traffic, decides signal time scheme in next time interval according to vehicles' positions from vehicle-positioning data center or/and vehicle queue, staying vehicles from vehicles' queue detectors of intersections, or/and in/out-vehicles from road-side vehicles' sources, which is centered or distributed or paralleled and implemented with software or/and hardware,

said vehicle-positioning data center collects and stores last vehicle positions of the queues in every phase apart from local intersection as queues' lengths, which data are from vehicles positioning equipment, mobile phone's positioning/navigation device binding to vehicle, or any device that is equipped with a positioning device;

said vehicle queues detector is any device that detects phase vehicle queue length, the position of last vehicles of a phase queue, such as video analysis device, ultrasonic, microwave, infra-red, coils etc;

said vehicle in/out detector of road-side vehicle source detects vehicles entrance to and exit from a vehicle source at a road-segment side, such as parking-meters at road-side, detectors at gates of parking lot, alleys without signals, entrance/exit-vehicles of highways, or any business/residential area with parking lot capability, multiple vehicle sources at a road-side may be combined into one source according to average distance from local intersection of them to make an estimate of their in/out-vehicles total;

said vehicle exit detector detects out-vehicles from intersection, gates of parking lot, alleys without signals, entrance/exit-vehicles of highways, or any business/residential area with parking lot capability,

said vehicle entrance detector detects entrance vehicles to a road-segment, parking lot, alleys without signals, entrance/exit-vehicles of highways, or any business/residential area with parking lot capability

said numbering vehicle detector includes coils, piezoelectricity, magnet-induct, infra-red, video or/and any device capable of numbering vehicles.

Another feature of the present system invention is that includes

Said A-A package including modules called as intersection-neurons in predict layer that predicts vehicles of corresponding intersections in next time interval based on detected vehicles in this time interval, modules called as pre-judge-neurons in analysis layer that analyzes over-thresholds information based on over-thresholds of vehicles received from their intersection-neurons in predict layer, modules called as overall trade-off in decision layer that trades-off the pre-judges received from their pre-judge-neurons in the analysis layer.

Another feature of the present system invention is that includes:

Said intersection-neurons in predict layer of A-A package being related to a real intersection one to one, among them detected and predicted data are exchanged dynamically according to need.

Another feature of the present system invention is that includes

Said intersection-neurons in predict layer of A-A package being input with phase vehicles queue in previous time interval, or/and out-vehicles of vehicles source of road-segment, their output are some predicted in next time interval remaining phase time, or/and out-vehicles, or/and vehicle queue change, or/and vehicles queue length, and their over-thresholds' information, send these information to corresponding pre-judge-neuron in analysis layer.

Another feature of the present system invention is that includes:

Said intersection-neurons in predict layer of A-A package including AI method module running the algorithms of neural network, statistical learning, or time series analysis.

Another feature of the present system invention is that includes:

Said pre-judge-neurons in analysis layer of A-A package being input with over-threshold related information from intersection-neuron, output signal time-offset or/and signals' temporary time-offset-table as pre-judges, to decision layer.

Another feature of the present system invention is that includes:

Said overall trade-off modules of decision layer of A-A package being input with pre-judges from analysis layer, output signal time instructions to executing layer, which trades-off choices, priority and schedule of these pre judges.

The advantages of the present invention are below: 1) its new invented mathematical mode for predicting traffic is closer to reality, A-A method and its package provides reliable theoretical support for predicting, solving queue-lead jam in metropolitan road-net; 2) its method may be only rely on the data about the vehicle queues from traffic-clouds and is easy to implement; 3) its lead green-waves for middle-big flow traffic, relief green-wave for near-saturated/saturated flow traffic, and differential green-wave for small flow traffic provides series, consecutive, systematic solution tools for dissolving jam core, early jam core, delaying queue-gathering large scale congestion in whole controlled area; 4) its adjusting signals time by quantumized queue change [symbol] Q_{d,j}^{Th0} with queue fluctuations, eliminates the costs from the queue changes and minimizes the costs, from the lead state for middle-lower loads to relief state for saturated load, pretty good avoids redundant stops about 1 time per period per road-segment per vehicle for 60 seconds gasoline consumption, usually about 30 minutes idle speed gasoline consumption of 30 stops-starts per road-segment; 5) its solitary wave is able to dynamically use remaining phase time of multiple intersections, deliver and dissolve suddenly-happened long vehicles queues out, in advance eliminate hidden troubles caused by the long queue chaos-congestion of “core-expansion style”, lessen green-light time waste, improve the efficiency of signals response and control with traffic; 6) its solitary wave and “A-A” method are universal for current road-net signal systems, with traffic data from traffic clouds, has wide application prospect, and its future is limitless when it implements and integrates the interaction functions with mobile terminal devices; 7) in spite of not integrating little-load-broad-band “0 red light” technique, pan-string also perform much better than current techniques, non-green-waves, green-waves: in a grid road-net it takes from anyone of 8 positions entering the net to get far subarea for a vehicle, assuming 1.5 intersections per green light with non green-wave, √n/2+3.83 red-lights with convection green-waves, when n=4, the red-lights 4.83, red-lights √n+1.83 with non green-waves, when n=9, the red-lights 4.83, the √n of non-green-wave or green-wave are strictly monotonically incremental with n, non-green-wave increases 0.5 faster than green-wave, whereas with this pan-string, as little as 4.83 red-lights, nothing to do with n, despite n=200×200 intersections spanning 50 square kilometers.

Note: \textcircled{1} said pan-string control method including 7 steps includes following spontaneous decay: 1)pan-string spontaneously decays to be differential green-wave when queue time-offset=0; 2) pan-string decays to be non differential green-wave state when no differential sensors are equipped with in intersections or “ban differential green-wave instruction” in step 7 are received.

### BRIEF DESCRIPTION OF THE DRAWINGS

FIG. 1 shows flowchart of traffic signal Pan-String control method;

FIG. 2 shows Pan-String Controlling String Mode Roadnet;

FIG. 3 shows Three-Layers Structure of Pan-String Control System;

FIG. 4 shows Roadnet Vehicle Queues, Flows and Their A-A Method Principle Diagram;

FIG. 5 shows PS suba4 at 630 s wz Signals, Qs, Predicts, Tides, SW, their Distributions;

### LIST OF REFERENCE NUMERAL UTILIZED IN THE DRAWING

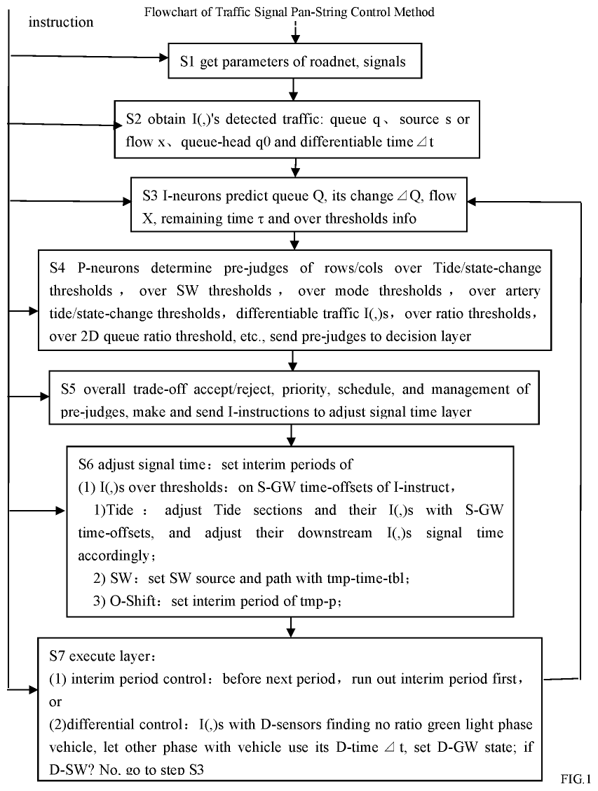

FIG. 1: I(,)—intersection (,) with coordinates (,); I-neuron—intersection-neuron; P-neuron—Pre-judge-neuron; Tide—fluctuation; SW—solitary wave; 2D—2 dimensions; S-GW—string greenwave; O-Shift—origin-of-shift; SW—solitary wave; D-sensors—differential sensors; D-time—differential time; D-GW—differential greenwave;

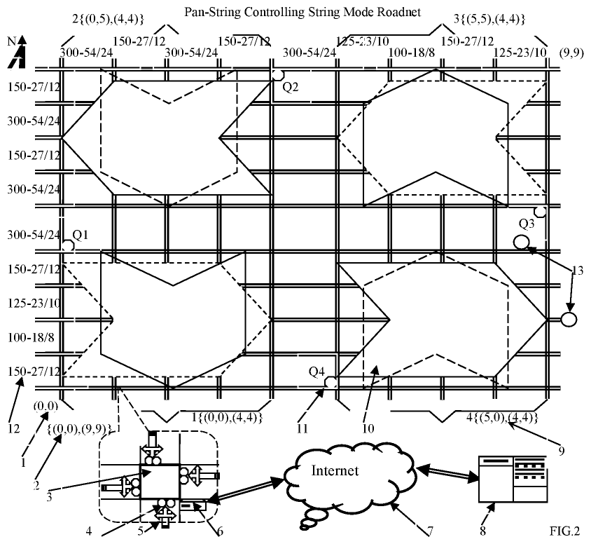

FIG. 2: a Left-Rotation Wormhole of String Supermode controlling a roadnet that is divided by “\” lines into 4 subareas, origins of 4 IDEN-Lead modes are Q1(0,5), Q2(4,9), Q3(9,5), Q4(5,0); 1—at lower-left corner, origin intersection coordinates (0,0) of a roadnet; 2—roadnet mark {(0,0),(9,9)}, for origin coordinates (0,0), the maximum and minimum coordinates (9,9) of row and column are 9 each; 3—intersection; 4—traffic signals; 5—vehicle queue; 6—traffic signals controller; 7—internet cloud; 8—control system center; 9—subarea mark 4{(5,0),(4,4)}, for number 4 area, its origin coordinates (5,0), the maximum and minimum coordinates (4,4) of row and column are 4 each; 10—master direction and its channel greenwave direction signed with solid line hollow arrow pointing at East-Right, slave greenwave direction signed with dotted line arrow; 11 origin of IDEN-Lead mode marked as Q and small octagon and its coordinates (5,0); 12—“#−#/#” for three values: distance between two adjacent intersections—Jammed Vehicle Queue (JVQ)-start-time/set-drive-time, unit: meter second/second; hereinafter follow the above;

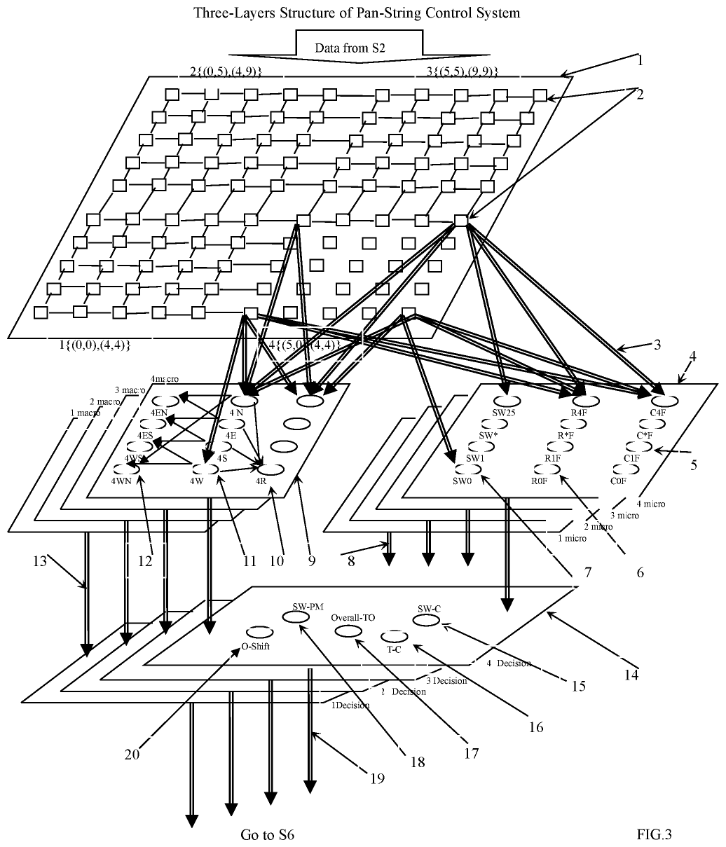

FIG. 3: 1—predict layer; 2—I-neuron and its modules of data input/predict; 3—linkages between predict layer and analysis layer; 4—subarea pre-judges modules of analysis layer, one module for one subarea; 5—P-neuron of the 1-st column I(,)s for fluctuation and state-change, denoted by C1F; 6—P-neuron of the 0-th row I(,)s for fluctuation and state-change, denoted by R0F; 7—P-neuron of the 0-th I(,) for solitary wave, denoted by SW0; 8—linkages between analysis layer and decision layer; 9—subarea macro-analysis module of analysis layer; 10—subarea 4′ ratio control, denoted by 4R; 11—subarea 4's big flow west control, denoted by 4W; 12—subarea big flows west-north grouping, denoted by WN; 13—linkages between analysis layer and decision layer; 14—subarea 4 of decision layer; 15—collision analysis of solitary waves, denoted by SW-C; 16—collision analysis of fluctuations, denoted by T-C; 17—overall trades-off, policy-decisions, denoted by Overall-TO; 18—solitary wave path management, denoted by SW-PM; 19—instruction codes making and configuration; 20—origin-of-shift, denoted by O-Shift;

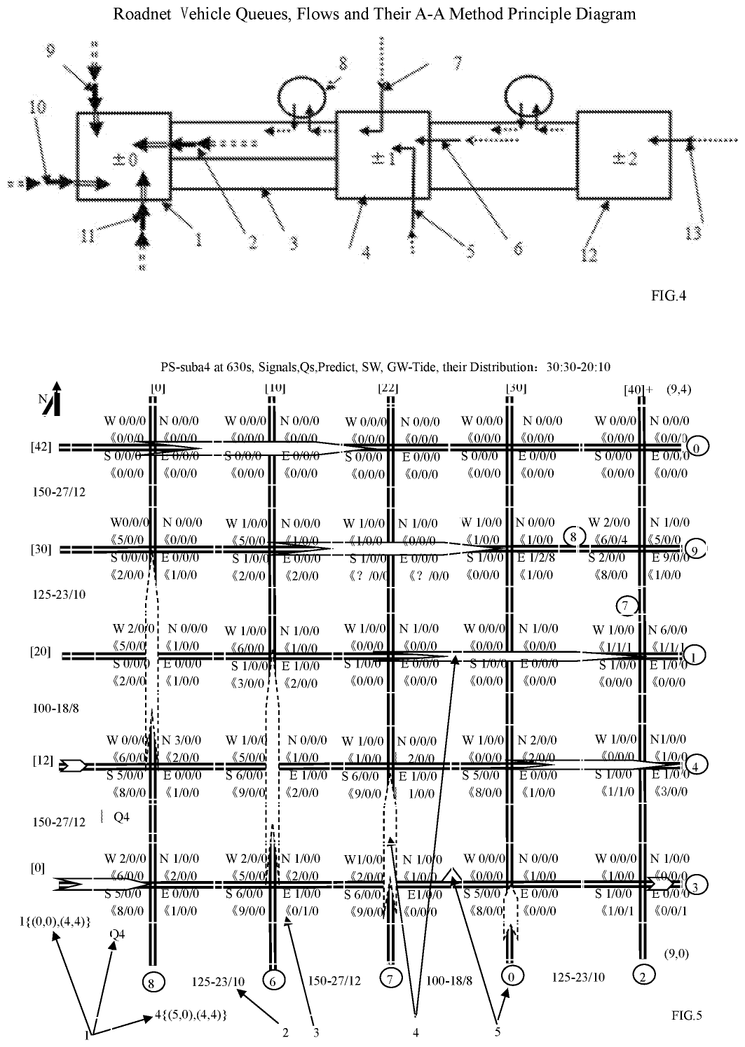

FIG. 4: 1—predicted 4 directions I(,), denoted as ±0; 2—predicted direction d=West vehicle queues, including straight phase j=1, left phase j=2, right phase j=3, arrow solid line for current queue Q_{d}(c-1) obtained with detection, arrow dotted line for a [symbol] Q_{d}(c−1) obtained with prediction, part of the arrow solid line in I(,) for vehicle out x_{d}(c); 3—road-segment linking between two I(,)s; 4—predicted direction West heading (d=East) upstream I(,), denoted as ±1; 5—upstream ±1 I(,)'s d=South left phase Q_{±1,d,1,j=2}(c−1) heading West to this ±0 I(,) d=East; 6—upstream ±1 I(,)'s d=East straight phase Q_{±1,d,1,j=1}(c−1) heading West to this ±0 I(,) d=East; 7—upstream ±1 I(,)'s d=North right phase Q_{±1,d,1,j=3}(c−1) heading West to this ±0 I(,) d=East; 8—upstream ±1 road-segment's vehicles sources S_{d}(c) inflow from the upstream ±0/outflow to this ±0 I(,) d=East, with AI method predict the net S_{d}(c)'s in/out; 9—, 10—, 11—predicted I(,)'s North queue Q_{±0,d=N}(c−1), West queue Q_{±0,d=w}(c−1), South queue Q_{±0,d=S}(c−1); 12—predicted direction d=East 2nd upstream I(,), denoted as ±2; 13 the 2nd upstream intersection's d=East straight phase Q_{±2,d,1,j=1}(c−1) predicted to heading West to this ±0 I(,) d=East;

FIG. 5: 1—subarea mark 4{(5,0),(4,4)}, denoted by suba4, for number 4 area, its origin coordinates (5,0) at lower left corner I(,) of the subarea, source I(,) Q4 of time-offsets of 2 dimension green-waves, master green-wave direction-East, slave direction-N; 2—between-I(,)s distance-traffic time denoted as #-#/#: meter-second/second, e.g., the label means row road-segment (0,1)'s distance D=125 meter, jammed vehicle queue (JVQ) start time tqd=23 second, set-drive-timetv=10 second according set-speed 45 km/h; 3—around I(,), “East”, “West”, “South”, “North” at 4 positions with 2 groups of numbers, 3 numbers each group for 3 phase queues, straight, left, right, separated by /, one group by detection, the other by prediction, separated by [symbol] e.g., “East 1/0/0 [symbol] 0/1/0” means intersection (1,1)'s East direction detected straight phase queue 1, left 0, right 0, and predicted straight phase queue 0, left 1, right 0, queue vehicle motion direction is West reverse of the phases' East, unit: standard vehicle, its corresponding impaired time is calculated with pre-determined standard vehicle queue length (such as 6.25 meter) and queue-impaired formula tqx=(1/ν0+α)*q, green-wave speed ν0=12.5 m/sec (45 km/h), α=0.18 and get tqx=0.26*q, for an example, 20 meter queue vehicles corresponds to 5 seconds and 3 standard vehicles; 4 master, slave green-waves' label's covering I(,)s and road-segments shows their current positions, such as the labeled slave green-wave North covering I(7,0) to I(7,1) has run for 8 seconds, the labeled master green-wave East covering I(7,2) to I(9,2) for 18 seconds with remaining 2 seconds; 5—circle for vehicle source, the ones at road ends means they connects to other areas or highways, the ones beside road-segments means by-road entrance/exit of parking lots or garages of residential/business/other function districts, and the triangle label Δ means by-road meter-park positions (assume average net in/out in this period is 0, omitted), wherein numbers are predicted vehicles in/out;

### DETAILED DESCRIPTION OF THE INVENTION

### Description of the Preferred Embodiments, Industry Applications

Detailed description of one embodiments of the invention in conjunction with the accompanying drawings:

As FIG. 1, Traffic signal pan-string control method flow chart, which is implemented into the control software of traffic control center system (ccs) as label 2-8 in FIG. 2, whole pan-string system includes 6 parts, “intersection systems” as label 2-6, with equipped “vehicle queue video analyzers” or/and “intersection vehicle out detectors”, “vehicle source Ss with equipped vehicles in/out detectors” as label 2-13, via bus 232/485/wifi and internet as label 2-7 connecting to the above ccs as label 2-8, or receiving from big data centers meter-precision grade mobile positioning data of intersections' phases queue q, vehicles in/out of Ss of road-segments, which ccs processes by 3 layers architecture of predicting modules as label 3-1 in FIG. 3, analyzing modules as label 3-4, deciding modules as label 3-14 produces instruction codes, send the codes to intersections; detailed are the following:

S1: obtain signals' parameters and its roadnet's parameters, (1) set RATIO mode, said roadnet's road-segments' traffic parameters, 1) set intersection's signals in roadnet with start direction North, Period=60 seconds, South-North/East-West 30 seconds each, straight phase 20 seconds, left 10 sec, 2) get road-segments' distance D and its set-drive-time tv=D/v0, according to speed v0=45 km/h=12.5 m/sec, and full jammed JVQ start time tqd=α*D, JVQ start coefficient α=0.18 seconds/meter, meanwhile, departing coefficient set 1 for keeping current state, omitting intersection width, column road-segment (0,1)'s parameters as label 2-12, #-#/#=D-tqd/tv=150-27/12; (2) string mode parameters, as FIG. 2, a): 1) area division, 2) and 3) omitted, get 4 subareas as label 2-9; b) set mode as Left-Rotation Wormhole of String, each subarea there are two hollow arrows pointing green-wave directions as label 2-10, wherein solid line arrow is for master direction and dotted line for slave ones, origin intersection of two green-wave time-offsets as label 2-11;
S2: obtain real time traffic information: queue-tail q from vehicle's binding positioning data from big data center or/and intersection traffic video 1 time per 10 seconds, vehicle sources' in/out vehicles s from detectors or from vehicle-binding positioning data of traffic data centers configured specially for any vehicle source, by-road meter-parking vehicles in/out obtained from their fee-meters, or/and intersections' coils detected vehicles in/out once per period, queue-head q0 obtained by intersection real time video 1 time per second as differential green-wave sensors, for phase-change quantum-time [symbol] t=6 seconds (differential-time), that's vehicles adjacent time-distance bigger than 6 seconds broad spectrum differential green-wave;
S3: intersection-neuron of an intersection as FIG. 3, wherein “A-A” method modules as label 3-2 constructs basic relations as label 4 about intersections' phase vehicle queues of last period, predicted queue Q and their change [symbol] Q, outflow X, and remaining phase time τ of next period, and according to pre-set micro thresholds [symbol] Q^{Th0}, critical thresholds Q^{ThC,} solitary wave Q^{ThS} generates and sends over-thresholds information by information channels as label 3-3 to pre-judge-neurons as labels 3-5 to 3-7, labels 3-9 to 3-12;
S4: prejudge-neuron as labels 3-5 to 3-7, labels 3-10 to 3-12, according to pre-set micro thresholds [symbol] Q^{Th0}, critical thresholds Q^{ThC,} solitary wave Q^{ThS}, received from predict layer, looks for number N/M of parallel road-segments row/column with same traffic direction, where downstream intersections' queues' change [symbol] Q^{Th0} of the road-segments exceeds [symbol] Q^{Th0}, exceeds number thresholds N^{Th0}/M^{Th0}, found N/M over threshold [symbol] Q^{Th0} generates a pre-judge of fluctuation, found Q exceeding threshold Q^{ThC} generates a pre-judge of state-change, as label 3-6 for the 0-th intersection row to find South-North queues fluctuation, South queue means northern intersection of the road-segment, North queue means southern intersection of the road-segment, make fluctuation and state-change same among the road-segments row/column, found queue Q over threshold Q^{ThS} generates a pre-judge of solitary wave (SW) after confirming remaining phase time T sufficient for the Q to pass by calculating the τ of every intersection along SW path from SW source as label 3-7, found queue Q over thresholds Q^{ThC}/Q^{ThS} of an artery road-segment generates a prejudge of artery fluctuation/solitary wave, found 2-dimension (2D) flows over thresholds as label 3-12 generates 2D mode change, found differentiable information generates differential green-wave, found flow-ratio over thresholds as label 3-10 generates ratio change;
S5: overall trade-off as label 3-17 by rules of collision-free solitary waves as label 3-15, collision-free solitary wave and fluctuation as label 3-16, solitary waves management as label 3-18, origin-of-shift as label 3-12, determine the pre-judges accept/reject, priority, schedule, and process how they are organized and run, and send out I-instructions for signal-parameter-adjust, fluctuation and state-change, solitary wave, mode-change, ratio-change, etc; for intersection with differential sensors detecting no ratio phase vehicle go to differential green-wave S7; during beginning there are little traffic, no I-instruction;
S6: adjust signal time (1) over thresholds intersections: configure interim periods, 1) fluctuation, 2) solitary wave; (2) intersections with no over thresholds carry out S7, or according to S5 “no I-instruction”, return to S7;
S7: execute (1) interim period control, after intersection's running out its interim period, run its next period; (2) differential control, by start instruction intersection with queue-head q0 (differential SW) sensors make differential operations: when vehicle at q0 is within safe distance <40 meter, allot one differential time (i.e., quantum phase-change time) [symbol] t to the q0 in a phase from current ratio phase time with no vehicle, and set a differential state; run for 630 seconds; intersections sill in a differential state are: below:
Channel-row 4: 5 intersections' queues are all same, {N0/0/0 [symbol] 0/0/0 E0/0/0 [symbol] 0/0/0 S0/0/0 [symbol] 0/0/0 W0/0/0 [symbol] 0/0/0}, other intersections automatically run ratio-rule signals due to their receiving high volume traffic accumulating longer queues, but their left phase queues are 0, no vehicle; these no differential SW intersections return S3;

embodiment of predicting next period Q(c)s, remaining phase time τ(c)s with “A-A” method of predicting package based on last period queue Q(c−1), following are the predicting steps, (1) construct all AI functions Ŝ_{d}(c)s of all vehicles sources' vehicles in/out time serial: let AI method 1 learn past vehicles in/out time distribution data of each vehicle source, obtain each Ŝ_{d}(c); (2) construct all AI functions μ\tilde{ }_{d}(c)s of all phase-vehicle-distribution: let AI method 2 learn past phase queue change [symbol] Q(c), vehicles out X(c) time distribution data of each direction-phases, obtain each μ\tilde{ }_{d}(c); here assume known Ŝ_{d}(c)s, μ\tilde{ }_{d}(c)s;

Subscript node: direction d={e,s,w,n}={East, South, West, North}, phase j={1,2,3}={Straight, left, right}, and 1 lane per phase, nd=1;

embodiment of predicting and constructing next period solitary wave as FIG. 5's intersection (4,2)'s north coming traffic;

I. Predict intersection phase vehicles out X(c) and remaining phase time τ(c), queue Q(c) and their change [symbol] Q(c) (predict layer):
1) Determine time of obtaining traffic data of intersection-neuron of intersection (4,2): it is before next period starts for non green-wave synchronous mode, or before next period of an intersection starts for green-wave asynchronous mode;
2) Determine intersections K_{d} covered to obtain traffic data by intersection-neuron of intersection (4,2) based on intersection phase time and mode:

for non green-wave synchronous mode, K_{d} covering intersections is from product of straight phase time τ and set-drive-speed ν0, τν0 distance covering intersections,

for green-wave asynchronous mode; all upstream intersections of this intersection including green-wave start-point, all downstream intersections of this intersection covered by product of straight phase time τ₁ and set-drive-speed ν0, τ₁*ν0 distance,

for this 2D green-wave mode, τ₁*ν0=20*12.5 m/s=250 m; for intersection (4,2)'s master direction upstream, covered intersections are I(3,2), I(2,2), I(1,2) and its green-wave start point (0,2), K_{d}=Kₑ=4; for I(4,2)'s downstream intersections, there is no intersection but one vehicle source, K_{w}=0; for I(4,2)'s slave direction upstream, covered intersections are 44,1), and its green-wave start point (4,0), K, =2; for I(4,2)'s slave direction downstream, 250 m covers I(4,3) with vehicle source, I(4,4) is not covered due to their distance 125+150=275 m that is beyond the phase time acting distance 250 m, Kₛ=1;

3) Obtain I(4,2)'s direction d phases' queue Q_{d,j}(c−1) and vehicles in/out of vehicle source S_{d}(c−1), and K_{d} covered I(*,*)'s Q_{±K,d,j}(c−1) and S_{±K,d,j}(c−1) in last period by detection, below are the data:
Q_{d,j}(c−1), W1/0/0, N9/0/0, E1/0/0+\textcircled{1}, S1/0/0, other data of I(*,*) as FIG. 5,
   4) Predict I(4,2)'s direction d vehicles in/out S_{d}(c) next period with source AI function Ŝ_{d}(c) based on S_{d}(c−1), the data as FIG. 5,
   5) Predict I(4,2)'s direction d phase vehicles distribution τ_{d}(c) next period: a) calculate μ_{d}(c−1) on detected [symbol] Q_{d,j}(c−1) and X_{d,j}(c−1); b) with source AI function μ_{d}(c) predict next period μ_{d}(c), assume that 100% straight phase is predicted, that's μ_{d}(c)=(straight, left, right)=(1,0,0);
   6) check I(4,2)'s direction d road-segment time offsets δc_{±k,dc} sign, being this 2D green-wave mode, vehicles moving direction d following the green-wave direction dc, δc_{±k,dc}>0, vehicles d retrograding the green-wave dc, δc_{±k,dc}<0; an option for “Q_{d,j}(c−1)” that should be detected can also be replaced by last period predicted and stored Q_{d,j}(c), or/and by estimate of last several predicted Q_{d,j}(c), (as assumed “ [symbol] #/#/#” of FIG. 5);
   7) Calculate I(4,2)'s direction d remaining phase time τ_{d}(c): known Q_{d,j}(c−1), S_{d}(c) as FIG. 5, μ_{d} c)=(1,0,0) and τ_{d,j}=20 s, road-segment D, green-wave set-drive-speed ν_{d}=12.5 m/s, VQ start-coefficient=0.18, phase vehicle out speed ν_{d,j}=0.5 vehicle/s, details are the following:

For no green-wave synchronous mode system, I(4,2)'s straight phase time τ_{d,j=1} minus queue pass time Q_{d,j}(c−1)/ν_{d}, if τ_{d,j=1}>0, minus the queues' upstream I(3,2)'s queue's queue-time-offset trq_{±k,d,j}(c−1) and I(3,2)'s queue's pass time Q_{±k,d,j}(c−1)/ν_{d}, then I(2,2)'s, I(1,2)'s, I(0,2)'s, till τ_{d,j=1}=<0;

For green-wave asynchronous mode system, vehicles direction d following the green-wave direction dc, δc_{±k,dc}>0:

(1) K_{d}=Kₑ=4 covering I(4,2) master direction West-coming upstream's I(3,2), I(2,2), I(1,2) and their green-wave start point (0,2), and Kr, =2 covering I(4,2) slave direction North-coming upstream's I(4,1) and their green-wave start point (4,0), trq_{±k,d,j}(δc_{dc})=−Q_{±k,d,j}(c−1)/ν_{d}*β<0, saturated traffic;

(2) remaining phase time τ_{d,j=1}(c) equals to the phase time τ_{d,j=1} minus queue pass time Q_{d,j}(c−1)/ν_{d}, then, minus the queues' upstream I(*,*)'s queue's queue-time-offset trq_{±k,d,j}(c−1) and I(*,*)'s queue's pass time Q_{±k,d,j}(c−1)/ν_{d} with μ_{d}(c) parts of them, one by one along I(2,2)'s, I(1,2)'s, I(0,2)'s, till τ_{d,j=1}=<0; all the decreased, μ_{d}(c) parts of the upstream times is sum as

$${\sum }_{k 1 = 1}^{k} {\prod }_{i = 0}^{k 1 - 1} {μ}_{\pm i , d} \times {q}_{\pm k 1 , d , j} / {v}_{d , j} ,$$

I(4, 2) west-coming,

τ_{4,2,e,1}=τ−{q_{±0}+└q_{±1}+q_{±2}+q_{±3}+q_{±4}┘}/ν_{d,j}=20−{1+0+1+1+2}×2=20−5×2=10,
I(4,2) south-coming is slave green-wave upstream, same theorem as above,

τ_{4,2,j=1}(·)=T_{d,j=1}−[q_{±0}+{q_{±1}+q_{±2}+s_{±2}}]/ν_{d,j}=20 −[1+1+0+2]×2=20−4×2=12,

vehicles d retrograding the green-wave dc, δc_{±k,dc}<0, K_{d} covering north-coming retrograding slave north-going green-wave queues' I(,) are none, even I(4,3) due to τ_{d,j=1}−2×tν₀=0; Kₛ=1 including 1 road-segment's vehicle source, K_{w}=1 including 1 vehicle source without I(,);

(1) retrograding green-wave, vehicles' drive-time is double, no one can reach and pass heading intersection, computes north-coming vehicles q=5 retrograding north green-wave, τ_{±0}−tν₀−δc_{n,dc}=0, no remaining phase time,

(2) same as non green-wave traffic, retrograding green-wave vehicle queues of road-segments covered by K_{d} are divided into categories as unsaturated trq_{±k,d,j} (δc_{dc})=Q_{±k,d,j}(c−1)*β>0, and saturated trq_{±k,d,j}(δc_{dc})<=0 (jamming),
North-coming,

trq_{±k,d,j}(δc_{dc})=trq_{±k,d,j}(−10)=20 −tgx_{±k,d,j}(c-1)_{q=6}>0, unsaturated,

(3) Unsaturated traffic remaining phase time τ\tilde{ }_{m,n,d,j=1}(c) equals to phase time τ_{d,j=1}(c) minus this I(4,2)'s queue q_{d,j} pass time q_{d,j}/ν_{d,j}, with τ\tilde{ }_{m,n,d,j=1}(c)>0 then continue minus k I(.)'s queues q_{±k,d,j} pass time with μ_{d}(c) parts of them covered by K_{d}, Πμ_{±i,d}×q_{±k,d,j}/ν_{d,j}, and their chasing queue-time-offset trq_{±(k1-1),d,j}(δc_{ac})'s sum

$${\sum }_{k 1 = 1}^{k} \{ {trq}_{\pm ( k 1 - 1 ) , d} ( δ {c}_{dc} ) + {\prod }_{i = 0}^{k 1 - 1} {μ}_{\pm i , d} \times {q}_{\pm k 1 , d , j} / {v}_{d , j} \} ,$$

trq_{d}(c)=0, for East coming queues and North coming queues, their K_{d} cover no intersections,
East-coming queues,

τ\tilde{ }_{4,2,w,1}=τ−[q_{±0}+{s_{±0}}]/ν_{d,j}=20 −[1+1]×2=20−2×2=16, detected q_{±0},
North-coming queues,

τ\tilde{ }_{4,2,s,1}=τ−[q_{±0}+{s_{±0}}]/ν_{d,j}=20 −[6+7]×2=20−14×2=−6, left 3 vehicles,

8) Calculate I(4,2)'s phase vehicles out X_{d,j}(c), known queue Q_{d,j}(c−1), vehicles in/out s_{d}(c) of vehicle source, μ_{d}(c), τ\tilde{ }_{d,j}(c), and phase time τ_{d,j}, phase lanes n_{d,j}, phase vehicle out speed ν_{d,j}, or detected with detectors instead of prediction, calculating steps as:

(1) Take queues q_{±k,d,j}(c−1) of k road-segments covered by K_{d}, following rules as above,

(2) check I(4,2)'s trq_{,d,1} (δc_{ac}), I(4,2)'s green-wave direction e same as west coming queue heading direction e, trq_{,e,1} (δc_{ac}) >0, otherwise, retrograding green-wave, trq_{,e,1}(δc_{dc})=tdqₑ−tqₑ−δcₑ other upstream I(,)s are same,

(3) x_{d,j}(c), equals to I(4,2)′ q_{±,d,j} (c−1) passed, when remaining phase time τ\tilde{ }_{4,2,d,1}>0, add upstream I(,)s' queues' μ_{d}(c) parts

$${\prod }_{i = 0}^{k} {μ}_{\pm i , d , j} {\prod }_{i = 0}^{k} {μ}_{\pm i , d} ( c )$$

to this I(4,2), till τ\tilde{ }_{4,2,d,1}<=0, when τ\tilde{ }_{4,2,d,1}<q_{±,d,j} (C-1)/ν_{d,j}, take τ\tilde{ }_{4,2,d,1}×ν_{d,j}, that's

$${\sum }_{k = 0}^{{K}_{d}} {\prod }_{i = 0}^{k} {μ}_{\pm i , d , j} \times {q}_{\pm ( k + 1 ) , d , j} \times {( {\tilde{τ}}_{\pm k} / t q {0}_{\pm ( k + 1 ) , d} )}^{{u}^{+} ( k - {K}_{d} )} ,$$

West coming traffic,

x_{4,2,e,1}=q_{±0}+{q_{±1}±q_{±2}±q_{±3}±q_{±4}}=1+0+1+1+2=5,
I(4,2) south coming traffic,

x_{4,2,n,1}=q_{±0}+{q_{±1}+q_{±2}+s_{±2}}=1+1+0+2=4,

Retrograding green-wave traffic, δc_{±k,d}: green-wave direction d reverse of traffic's, trq_{,e,1}(δc_{dc}) <0, take Q(c) predicted in last period or/and take estimate from last few pairs of predicted Q(c)/detected Q(c−1), (as assumed “ [symbol] ” in FIG.),
East coming traffic,

x_{4,2,w,1}=q_{±0}+{s_{±0}}=1+1=2,
North coming traffic,

x_{4,2,s,1}=q_{±0}+{s_{±0}}=6+7=13,

9) Calculate I(4,2)'s phase arrival vehicles A_{d,j}, known X_{±1,d,1},X_{±1,d2,2}, X_{±1,d3,3}, S_{±1,d,1}, μ_{±0,d},

West neighbor coming traffic,

X_{3,2,e,1}=q_{±0}+{q_{±1}+q_{±2}+q_{±3}}=0+1+1+2=4,X_{3,2,s,2}=0,X_{3,2,n,3}=0,

South neighbor coming traffic,

X_{4,1,n,1}=q_{±0}+{q_{±1}+s_{±2}}=1+0+2=3,X_{4,1,e,2}=X_{4,1,n,3}=0,S_{±2,n}(C)=2,

East neighbor coming traffic,

X_{5,2,w,1} does not exist,

North neighbor coming traffic,

X_{4,3,s,1}=q_{±0}+{q_{±1}}=5+0=5,X_{4,3,w,2}=0,X_{4,3,e,3}=0,S_{±0,s}(c)=7,

As assumed traffic taking only straight phase, not going other phases, μ_{m,n,e} (c)=(1,0,0) for convenience of computation, we obtain,

A_{4,2,e,1}(c)−X_{3,2,e,1}+X_{3,2,s,2}+X_{3,2,n,3}=4+0+0=4,A_{4,2,s,2}−0,A_{4,2,e,3}=0,

A_{4,2,n,1}(c)−X_{3,2,n,1}+X_{3,2,e,2}+X_{3,2,w,3}−3+0+0−3,A_{4,2,n,2}−0,A_{4,2,n,3}=0,

A_{4,2,s,1}(c)−X_{3,2,s,1}+X_{3,2,w,2}+X_{3,2,e,3}+S_{4,3,e,1}−5+0+4+7=16,A_{4,2,s,2}=0,A_{4,2,s,3}=0,

A_{4,2,w,1}(c)−S_{w,1}−1,A_{4,2,w,2}=A_{4,2,w,3}=no exist,

10) Calculate I(4,2)'s phase queue change [symbol] Q_{d,j} (c), using known X_{d,j}(c), A_{d,j}(c),

[symbol]

Q_{4,2,e,1}(c)−A_{4,2,e,1}(c)−X_{4,2,s,1}(c)=4−5−1, [symbol] Q_{4,2,e,2}(c)−A_{4,2,e,2}(c)−X_{4,2,e,2}(c)=0−0=0,

[symbol]

Q_{4,2,n,1}(c)−A_{4,2,n,1}(c)−X_{4,2,n,1}(c)=3−3=0, [symbol] Q_{4,2,n,2}(c)−A_{4,2,n,2}(c)−X_{4,2,n,2}(c)=0−0=0,

[symbol]

Q_{4,2,s,1}(c)−A_{4,2,s,1}(c)X_{4,2,s,1}(c)=16−10=6, [symbol] Q_{4,2,s,2}(c)−A_{4,2,s,2}(c)−X_{4,2,s,2}(c)=0−0=0,

[symbol]

Q_{4,2,w,1}(c)−A_{4,2,w,1}(c)X_{4,2,w,1}(c)=1−2−1, [symbol] Q_{4,2,w,2}(c)−A_{4,2,w,2}(c)−X_{4,2,w,2}(c)=0−0=0,

[symbol]

Q_{4,2,e,3}(c)= [symbol] Q_{4,2,n,3}(c)= [symbol] Q_{4,2,s,3}(c)= [symbol] Q_{4,2,w,3}(c)=0,

11) Calculate I(4,2)'s phase queue Q_{d,j} (c), using known Q_{d,j}(c−1), [symbol] Q_{d,j}(c),

Q_{4,2,e,1}(c)=Q_{4,2,e,1}(c−1)+ [symbol] Q_{4,2,e,1}(c)=1−1=0,

Q_{4,2,n,1}(c)=Q_{4,2,n,1}(c−1)+ [symbol] Q_{4,2,n,1}(c)=1+0=1,

Q_{4,2,s,1}(c)=Q_{4,2,s,1}(c−1)+ [symbol] Q_{4,2,s,1}(c)=6+6=12,

Q_{4,2,w,1}(c)=Q_{4,2,w,1}(c−1)+ [symbol] Q_{4,2,w,1}(c)=1−1=0,

12) Obtained a double over thresholds queue Q_{4,2,s,1}(c)=12>Q^{ThS}=10 and [symbol] Q_{4,2,s,1}(c)=6> [symbol] Q^{ThS}=5, here assumed absolute solitary wave threshold Q^{ThS}=10(car), its relative threshold Q^{ThS}=5(car) at predict layer and sent to analysis layer,
II. Determine solitary wave source and its path (analysis layer):
13) Determine solitary wave source (analysis layer): determine remaining phase time of an I(,) with double over thresholds of Q^{ThS} and [symbol] Q^{ThS},

With Q^{ThS}=10 (car) and [symbol] Q^{ThS}=5 (car), determine a phase queue that is suddenly increased: found I(4,2)'s north coming vehicles heading south queue Q^{S} suddenly increases 6+6=12>10(car)=Q^{ThS} and +6>5(car)=a Q^{ThS} calculate and check whether or not I(4,2)'s phases have sufficient remaining time for the Q^{S} to pass, I(4,2)'s remaining phase time τ\tilde{ }_{4,2,d,j},

West coming traffic,

τ\tilde{ }_{4,2,e,1}=τ\tilde{ }{q_{±0}+[q_{±1}±q_{±2}±q_{±3}±q_{±4}]}/ν_{d,j}==20 −{1+0+1+1+2})(2=20−5×2=10,

South coming traffic,

τ\hat{ }_{4,2,n,1}=τ\hat{ }{q_{±0}+[q_{±1}+q_{±2}+s_{±2}]}/ν_{d,j}=20−{1+0+2}×2=20−4×2=12,

East coming traffic,

τ\hat{ }_{4,2,w,1}=τ\hat{ }{q_{±0}+[s_{±0}]}/ν_{d,j}=20 −{1+1}x2=20−2×2=16,

North coming traffic,

τ\hat{ }_{4,2,s,1}=τ\hat{ }{q_{±0}[s_{±0}]}/ν_{d,j}=20−{6+7}×2=20−14×2=−6,“−6” means left 3 vehicles unable to pass,

In second half period, remaining turning phase's time 10 s with no turning queue, can be used for the “−6” 3 vehicles to pass, is sufficient, as a solitary wave source of I(4,2)'s north coming queue;

solitary wave source signal time set: E-W straight phase time 20 s, turn time 10 s, S-N straight time 20 s, turn time 10 s;

14) Determine solitary wave (SW) path (analysis layer):check if in SW direction there are I(,)s with consecutive and sufficient remaining time,

The SW queue is 13 and needs 26 s to pass,

North coming SW queue 13 heading south, retrograding SW going by I(4,1),I(4,0) with their phases' queues predicted or estimated:

I(4,1) west [symbol] 2/0/0, north [symbol] 1/0/0, East [symbol] 3/0/0, South [symbol] 1/1/0, 8 seconds later than I(4,2)'s time-offset, reaching 44,1) needs 8 seconds, 44 seconds left no running; at that time, East master GW has used straight phase 16 s remaining 4 s, turn phase remaining 10 s, S-N straight 18 s, turn 8 s, totally 40 s unused;

I(4,1), going by GW heading south of SW source I(4,2), is set path time-table: E-W straight 2 s, turn 6 s, S-N 26 s, turn 10 s, using time following period,

I(4,0) west [symbol] 1/0/0, north [symbol] 0/0/0, East [symbol] 0/0/1, South [symbol] 1/0/1, 12 seconds later than I(4,1)'s time-offset, E-W straight has used 20 s, reaching I(4,0) needs 12 seconds, 28 seconds left no running; at that time, S-N remains straight 18 s, turn 8 s, totally 26 s unused;

I(4,0), going by GW heading south of SW source I(4,2), is set path time-table: S-N straight 24 s, turn 4 s, using time following period,

Send information “SW(4,2)South-2” to decision layer; note, “SW(4,2)South-2” means solitary wave, intersection (4,2) is SW source, direction South, going by 2 intersections;

### III. Overall Trade-Off (Decision Layer)

15).overall trade-off: after trading-off pre-judges from analysis layer based on collision-free and priority rules of overall trade-off, make and send I-instructions “SW(4,2)South-2”: (1) no collision with SWs; (2) no collision with “Fluctuation row{*, 0}North-t gw”; (3) SW stage management: SW(4,2)South-2 going by I(4,1),I(4,0), make and send I-instruction to SW path of I(,)s including I(4,2),I(4,1),I(4,0) with the I(,)s' time-tb1 that should be carried out;
IV. Next Period Start with New Time Set (I-Instruction Decodes, Execute Layer)
16) Make interim period and orders of “SW(4,2)South-2” I(4,2),I(4,1),I(4,0) based on their time-tb1, in order to change smoothly into solitary wave;
The following shows embodiment of subarea row/column fluctuation and state-change operations:

Embodiment of predicting and constructing next period fluctuation and state-change as FIG. 5's road-segment row;

1) Obtain I(,)s' Q(c−1), Q(c) at time 630 s-th before next period of 2D origin I(0,0), (I-neuron of predict layer)

As FIG. 5, labels “N*/*/* [symbol] */*/* E*/*/* [symbol] */*/* S*/*/* [symbol] */*/* W*/*/* [symbol] */*/*” around I(,)s means direction and its last period detected 3 phases queues with ((followed by its predicted 3 phases queues;

2) Find I(,)s over fluctuation/state-change thresholds [symbol] Q_{d,j}^{Th0}/Q_{d,j}^{ThC}, [symbol] Q_{d,j}^{Th0}=3(car), (I-neuron of predict layer)

With [symbol] Q_{d,j}^{Th0}=3, find all S-N parallel road-segments {*, 0}, that's 0-th S-N road-segments, using I(,) coordinates express as {(0,0)-(0,1),(1,0)-(1,1),(2,0)-(2,1),(3,0)-(3,1),(4,0)-(4,1)}, 5 S-N parallel road-segments, running North slave green-wave, their queues at south heading north of the I(.)s are found increased Q(c−1) [symbol] Q(c), in order as 5 [symbol] 8, 6 [symbol] 9, 6 [symbol] 9, 5 [symbol] 8, 1 [symbol] 1, (q(c)−q(c−1))={3,3,3,3,0};

3) Find road-segments over row/column fluctuation/state-change thresholds N^{Th0}/M^{Th0}, (P-neuron of analysis layer),

Find same heading 4 I(,)s queues' change of the 4 road-segments out of 5 over the thresholds M^{Th0}, Q(c)−Q(c−1)=3>= [symbol] Q^{Th0}=3, M=4>=Mₘₐₓ/2=M^{Th0}=5/2=2.5, satisfying for fluctuation optimized condition, and, this fluctuation is satisfying for state-change threshold Q_{0,n}^{ThC}=7,

4) Calculate average fluctuation time-offset t-gw of the above sections (P-neuron of analysis layer) average fluctuation time-offset t⁻gw: fluctuation queue time-offset [symbol] trq= [symbol] tqx=−0.26* [symbol] q=−0.26*(q(c)−q(c−1)), convert q values in FIG. 5 into queue length on standard vehicle length (m), 6.25 m/car, by trq calculation, meters is converted into seconds, such as [symbol] Q^{Th0}=3(cars)=>18.75 m=>4.875 s, Q_{*,0,n}^{ThC}=7 (cars)=>46.15 m=>7.4 s, due to first fluctuation, directly use predicted q(c) instead of (q(c)−q(c−1)) to calculate { [symbol] trq}={q(c)s}={8,9,9,7,(7)}(cars)=>{50,56,56,44,(44)} (meters)=>{13,15,15,11,(11)} (seconds)=>t⁻gw=−13 (seconds),

Road-segments{*, 0}'s fluctuation queue time-offsets [symbol] trq*_{,0,n}=0.26* [symbol] q=−0.26*q(c)=−13 second;

5) With pre-judge scheme, calculate time-offset group (P-neuron of analysis layer)
Raw time-offset matrix as FIG. 5:

$$\{ \begin{matrix}42 & 52 & 4 & 12 & 22 \\ 30 & 40 & 52 & 0 & 10 \\ 20 & 30 & 42 & 50 & 0 \\ 12 & 22 & 34 & 42 & 52 \\ 0 & 10 & 22 & 30 & 40\end{matrix} \} ,$$

no fluctuation before,
Based on t⁻gw=−13 make fluctuation scheme,
For downstream I(,)s of fluctuation source I(,)s={I(0,1),I(1,1),I(2,1),I(3,1),I(4,1)}, their raw time-offsets are decreased by 13,
After decreasing 13, time-offsets matrix:

$$\{ \begin{matrix}42 - 13 & 52 - 13 & 4 - 13 & 12 - 13 & 22 - 13 \\ 30 - 13 & 40 - 13 & 52 - 13 & 0 - 13 & 10 - 13 \\ 20 - 13 & 30 - 13 & 42 - 13 & 50 - 13 & 0 - 13 \\ 12 - 13 & 22 - 13 & 34 - 13 & 42 - 13 & 52 - 13 \\ 0 & 10 & 22 & 30 & 40\end{matrix} \}$$

Satisfied with state-change threshold, make state-change operation: remember row/column of state-change,
Send “Fluctuation row{*, 0}North-t⁻gw” to decision layer, note: “Fluctuation row{*, 0}North-t⁻gw” means 0-th row parallel S-N road-segments north queue time-offsets t⁻gw,
6) Overall trade-off and coordinate (decision layer): check, coordinate, collision-solution, no collision, send I-instruction of fluctuation including “Fluctuation row{*, 0}North-t⁻gw”;
7) Decoding and executing I-instruction (execute layer): according to I-instruction of fluctuation, get fluctuation queue time-offset−t⁻gw and I(,)s of executing fluctuation, make interim periods, and send them to the I(,)s;
get fluctuation queue time-offset −t⁻gw=−13, and I(,)s executing fluctuation, make interim periods−13mod(60)=+47=24+23, configure the interim period to the I(,)s as:
   Interim period matrix of fluctuation t⁻gw=−13:

$$\{ \begin{matrix}24 + 23 & 24 + 23 & 24 + 23 & 24 + 23 & 24 + 23 \\ 24 + 23 & 24 + 23 & 24 + 23 & 24 + 23 & 24 + 23 \\ 24 + 23 & 24 + 23 & 24 + 23 & 24 + 23 & 24 + 23 \\ 24 + 23 & 24 + 23 & 24 + 23 & 24 + 23 & 24 + 23 \\ 0 & 0 & 0 & 0 & 0\end{matrix} \} .$$

What is claimed as new and desired to be protected by Letters Patent is set forth in the following:

1. A traffic signal Pan-String control method, also named as A-A method, includes steps:
S1: obtain signal parameters and its roadnet's parameters;
S2: detect in every direction d of all intersections queues Q, numbers of waiting vehicles, or/and numbers s of vehicles in and out from vehicles' sources of same vehicle motion direction road-segment, amounts of vehicles in and out, or including numbers x of vehicles leaving the road-segment, outflow x, or/and queue-head's position q0 and phase-change differential-time [symbol] t^{Th0};
S3: predict queue Q and its change [symbol] Q, outflow x and remaining green signal time, remaining-phase-time, \tilde{τ}, in direction and phase in next time interval, with intersection-neuron, I-neuron, of predict layer;
S4: pre-judge signal parameter optimization, fluctuations of signal time-offsets between intersections, or/and shift of source intersection, shift-of-origin, of a green-wave due to traffic change in two cross directions in a roadnet, or/and solitary wave for said Q and [symbol] Q according to budgeting signal time combining remaining phase times τ(c) of relevant intersections and direction, or/and artery-fluctuations or -solitary wave, or/and 2 dimensional traffic flows' mode change, or/and differentiable intersection with no vehicles in a phase, or/and roadnet signal ratio change, in next time interval, with pre-judge-neuron, P-neuron, in analysis layer;
S5: overall trade-off pre-judges: accept or reject, priority, schedule, make and send out I-instructions for signal-parameter-adjust, directly go to S7 for intersections with no ratio phase vehicle and instruction, with decision layer;
S6: adjust signal time according to I-instruction: (1) intersections with over-thresholds adjust time-offsets: 1) configuring interim-periods of fluctuation state-change codes and its time-offsets tgw for intersections of fluctuation related road-segment and downstream intersections, 2) making and sending solitary wave order-codes that include scheme of times of every direction and phase of solitary wave source intersection and its downstream intersections, 3) configuring interim-period of said shift-of-origin, (2) other intersections with lower-thresholds carry out S7;
S7: execute: (1) interim-period: run new period after an intersection runs out its interim-period of a mode or/and its temporary time-table or/and (2) differential control: intersections equipped with differential sensors, D-sensors, of vehicles or by differential instruction: analyze queue-head q0's positions of every phase of an intersection, decide when to do differential green-wave (or called phase-change quantum/differential) control: assign a phase-change differential time (quantum-time) [symbol] t^{Th0} of a current ratio phase green light time with no vehicle q0 within pre-determined safe distance for a vehicle to brake at an intersection to a phase with vehicle q0 and banning re-differential; non-differential state of an intersection go back to S3;
Said queue Q of vehicles is measured in meter or vehicles, which length means queue length of a queue about the number of standard vehicle includes the distance between two adjacent vehicles which can be converted in meter-measurement of a vehicle queue;
Said vehicles means the vehicles converted into standard vehicles;
Said next time interval refers to signal period C and its multiple 1C, 2C, 4C, 8C, can be used in any signal network to predict queue Q of vehicles.

2. A method as defined in claim 1, wherein the method includes:
S3-1 Said predicting queue Q and its change [symbol] Q including: (1) add detected vehicles a entering a road-segment in direction d from its immediately upstream intersection or/and take the sum of vehicles out x_{±1,d1,j1}(c), x_{±1,d2,2j}(c), x_{±1,d3,j3}(c) from upstream intersection phases, and vehicles out s in the d direction from traffic source S_{d}(c) in the road-segment merging into the d direction, obtain predicted vehicles arrival a_{±0,d} of an intersection-direction d, (2) then by multiplying phase-vehicle-distribution coefficient μ_{d}(c) of the intersection-direction obtain predicted phase vehicles arrival a_{d,j}(c) of the intersection-direction, (3) then by decreasing phase vehicles out x_{±0,d,j} from the predicted phase vehicles arrival a_{d,j}(c), obtain a predicted phase change [symbol] Q of queue Q, (4) then by adding the predicted phase change [symbol] Q to queue Q_{d,j}(c−1) in last time interval, obtain a predicted phase vehicle queue Q_{d}(c);
Said ±k,d,j of x_{±0,d,j}, as subscripts, in the order of their positions, ±stand for the intersection of the k-th road-segment in upstream, d for traffic heading direction, j for signal phase, k=0 for a local intersection, k=1 for an adjacent intersection, k=2 for a 2^{nd} adjacent intersection, and so on; for a local intersection, its subscripts variables may be for short q_{d,j}(c) or q_{d}(c) or q_{±0}(c) or q_{m,n,d,j}(c) with ±k omitting, ‘m,n’ for an intersection's coordinates,
Said traffic source S_{d}(c) is predicted by a traffic source AI function Ŝ(c) based on data S_{d}(c-1) detected or predicted in last time interval; the traffic source AI function Ŝ(c) is obtained by an AI learning method trained with data past or on-line;
Said phase vehicles, for sharing lane of multi-phases, is determined still by phase-traffic-distribution-coefficient μ_{d}(c);
Said traffic source of a road-segment including multi-traffic sources in a road-segment direction have their time-offsets to their downstream intersection determined by their average distance to the intersection, usually taking their average time-offset or with 0 time-offset;
Said AI learning method includes Artificial Neuron Networks ANN, Chaos Time Series, Wavelet theory, Statistical Regression and Support Vector Machine SVM, Genetic Optimization GA, Particle Swarm Optimization PSO, Fuzzy Analysis and Information Granulation, and their Comprehensive use, hereinafter the intelligent methods mentioned as same as the above;
Said phase vehicles out x_{±0,d,j}(c), x_{±1,d1,j1}(c), x_{±1,d2,2j}(c), X_{±1,d3,j3}(c) of a direction are obtained by the following method predicting or with equipped phase-vehicle-out detectors detecting.

3. A method as defined in claim 1, wherein the method includes:
S3-1-1 phase-vehicles-distribution coefficient μ_{d}(c) is predicted with phase-vehicles-distribution AI function \hat{μ}_{d}(c) and last time interval's predicted values μ_{d}(c−1);
Said predicted values μ_{d} (c−1) is computed out based on detect in steps: (1) obtain [symbol] Q_{d,j}(c-1) by subtracting detected phase vehicles' queues in the previous two corresponding time intervals, (2) obtain phase vehicles out x_{d,j}(c−1) by phase green time τ_{d,j} multiplying phase vehicles' rate out ν_{d,j}; when traffic is light, use predicted phase vehicles out in previous time interval as “current detected” phase vehicles out, or/and directly use detected phase vehicles out, (3) obtain phase arrival vehicle a_{d,j}(c−1) by adding obtained [symbol] Q_{d,j}(c−1) and x_{d,j}(c−1), (4) obtain a phase-vehicles-distribution μ_{d,j}(c−1) by the a_{d,j}(c−1)s' being divided by the sum of the three a_{d,j}(c−1) vehicles;
Said phase vehicles' out rate ν_{d,j} means vehicles leaving intersection-stop-line per second;
Said phase-vehicles-distribution AI function \ddot{μ}_{d} (c) is an intersection-direction-phase vehicles time distribution obtained by Artificial Intelligence method trained with the past traffic data.

4. A method as defined in claim 1, wherein the method includes:
S3-1-2 phase vehicles out x_{d,j}(c) are vehicles predicted that are from local queues, upstream intersections' vehicles out x_{±k,d,j}(c), and upstream road-segments' traffic sources s_{±k,d,j}(c), that their needed intersections' pass time and road-segments' travel time are local intersection phase green light time by computing remaining-phase-time τ_{±k,d,j}(c), k=0,1,2, . . . , for remaining-phase-time τ_{±k,d,j}(c)>=0 for its queue Q_{±k,d,j}(c−1), x_{±k,d,j}(c) is taken into account; and for remaining-phase-time τ_{±k,d,j}(c)<0 for its queue Q_{±k,d,j}(c−1), x_{±k,d,j}(c) is taken into account according to τ_{±k,d}, divided by phase vehicles rate out ν_{±k,d,j}; the predicted vehicles out x_{±k,d,j}(c) is computed based on the detected vehicles queue q_{±k,d,j}(c−1), k=0, 1, 2, . . . ;
Said remaining phase time function τ_{d,j}(c) is predicted with the following claimed method; or/and is detected and computed with detectors for vehicles out x_{d,j}(c).

5. A method as defined in claim 1, wherein the method includes:
S3-1-3 remaining phase time τ_{d,j}(c) is a predicting function that a phase time subtracts pass time predicted for current phase vehicles queues with existing queue-time-offset trq_{±k}(c) and the phase queue pass time tq0_{±k,d,j}(c) from a local intersection to its upstream intersections' queues q_{±k,d,j}(c) and including their road-segments' traffic sources S_{±k,d,j}(c), k=0, 1, 2, . . . , until the remaining phase time τ_{d,j}(c) becomes 0 or smaller;
Said phase queue pass time tq0_{d,j}(c) is obtained with queue Q divided by phase speed ν_{d,j};
Said queue-time-offset trq_{±(k-1)}(c) of upstream k-th (k>1) intersection's queue and its heading intersection's queues is obtained with set-drive-speed ν_{d,(k-1)} dividing the (k-1)−th road-segment length D_{±(k-1)}, then subtracting the product of queue q_{±(k-1)}(c) and queue-impaired factor β; for vehicles following green-wave motion with time-offsets |δc_{±i,dc}|>0, trq_{±(k-1)}(c)=−β×q_{±(k-1)}(c)<0, and when queue q_{±(k-1)}(c) is small, trq_{±(k-1)}(δc_{±(k-1),dc}) is close to 0, for vehicles retrograding green-wave motion, its trq_{±(k-1)}(δc)=2×tν0_{±(k-1)}(0)−β×q_{±(k-1)}(c);
Said queue-impaired factor β=1/ν_{d,(k-1)}+α, is the sum of the reciprocal of set-drive-speed ν_{d,(k-1)} and queue-start coefficient α;
Said queue-start coefficient α means start-time per queue-meter, unit, second per meter, the estimated range from 0.14 to 0.22, take the median 0.18, adjusted according to empirical data;
Said time-offsets δc_{±i,dc} is the i-th road-segment divided by set-drive-speed ν_{d,(k-1)}, get tν0_{±i}.

6. A method as defined in claim 1, wherein the method includes:
S3-1-4 phase queue Q_{m,n,d,j}(c) and its change [symbol] Q_{m,n,d,j}(c) predicted by an intersection-neuron and found over the follow thresholds will be sent out for further analysis, the thresholds includes minimum queue-change-threshold [symbol] Q^{Th0}, state-threshold Q^{ThC}, minimum relative solitary wave queue-difference threshold [symbol] Q^{Th0}, minimum absolute solitary-wave queue-length threshold Q^{ThC} Said minimum queue-change-threshold [symbol] Q^{Th0} means a designed minimum queue change during a time interval;
Said state-threshold Q^{ThC} is a queue length as the change point of two green-wave directions;
Said minimum relative solitary wave queue-difference threshold [symbol] Q^{ThS} means a designed minimum queue length difference relative to other phase queues' lengths;
Said minimum absolute solitary-wave queue-length threshold Q^{ThS} means a designed minimum queue length for a solitary wave.

7. A method as defined in claim 1, wherein the method includes:
S3-1-5 time before which traffic data are acquired by intersection-neurons of predict layer is next period start instant for non-green-wave and synchronous mode systems, or an intersection's next period start instant for green-wave mode systems.

8. A method as defined in claim 1, wherein the method includes:
S3-1-6 intersections' index range K_{d} from which traffic data are acquired by an intersection-neuron of predict layer is the number of downstream intersections vehicles move and pass by during phase time τ_{d,j=1} green light time of local intersection of an intersection-neuron, is covered by sum of distances of K_{d} road-segments, each of which equals to τ*ν0, where τ is green-light time, ν0 is set-drive-speed, i.e.,
$$τ > {{\sum }_{i = 0}}^{{K}_{d}} {D}_{\pm i} / v 0$$
for non-green-wave synchronous mode systems, or is all upstream intersections including source-intersection from local intersection for traffic following green-wave and downstream intersections for traffic retrograde green-wave covered by the sum of distances of K_{d} road-segments and their time-offsets δcᵢ, i.e.,
$$τ > {\sum }^{u} ( {D}_{\pm i} / v 0 + \vert δ {c}_{i} \vert ) ,$$
and where K_{d} does not cover last downstream road-segment but or covers its traffic source S for green-wave mode systems.

9. A method as defined in claim 1, wherein the method includes:
S4-1 pre-judges fluctuation of signal time-offsets by a pre-judge-neuron in analysis layer based on said Q and [symbol] Q exceeding thresholds [symbol] Q^{Th0}, Q^{ThC} received from intersection-neurons in corresponding row and column whether or not the number of the road-segments in the same row or column, and their downstream traffic direction as an intersection-neuron's intersection is in and concerns traffic direction exceeds rows threshold M^{Th0} or column threshold N^{Th0}, for yes, determines the fluctuation of signal time-offsets, for the shorter green-light time or overlong road-segment does not analyzes the row threshold M^{Th0} or column threshold N^{Th0} but analyzes independently the fluctuation of signal time-offsets for road-segments of intersection-neuron's intersection.

10. A method as defined in claim 1, wherein the method includes:
S4-2 pre-judge shift of origin by a pre-judge-neuron in analysis layer based on said Q and [symbol] Q exceeding thresholds [symbol] Q^{Th0}, Q^{ThC} of intersections in directions received from intersection-neurons of intersections: calculates total traffic volume or/and queue Q_{d}=ΣₘΣₙ q_{m,n,d}/n_{m,n,d} and its total change [symbol] Q_{d}=ΣₘΣₙ [symbol] q_{m,n,d}/n_{m,n,d} of every intersection in every direction d in roadnet, for [symbol] Q_{d} bigger than [symbol] Q^{ThM}_{d}, with two bigger Q_{d} s, makes the reset time-offset table of shift of origin.

11. A method as defined in claim 10, wherein the method includes the steps of:
S4-3 pre-judge solitary wave by a pre-judge-neuron in analysis layer based on said Q and [symbol] Q exceeding thresholds [symbol] Q^{ThS}, Q^{ThS} determines whether or not local intersection has remaining phase time \hat{τ} available for the over-thresholds Q and [symbol] Q, for yes, makes solitary wave.

12. A method as defined in claim 10, wherein the method includes:
S4-3-1 pre judge said solitary wave by: (1) pre-judge a solitary wave source: calculate remaining phase time \hat{τ}_{S} in every direction of local intersection on received queue Q and its changes [symbol] Q exceeding relative threshold [symbol] Q^{ThS} and absolute threshold Q^{ThS}, find a \hat{τ} long enough for Q^{S}=Q^{ThS} or shorten Q to pass and then configure a temporary timetable for a solitary wave source of the Q^{S} to pass, (2) pre Jude a solitary wave path: based on drive time from the solitary wave source to pass its downstream intersections, pre-judge remaining phase time \hat{τ} of downstream intersections, find these \hat{τ}_{S} long enough for Q^{S}=Q^{ThS} to pass, and then configure a temporary timetable for the solitary wave path of the Q^{S} to pass.

13. A method as defined in claim 1, wherein the method includes:
S5-1 overall trade-off rules about pre-judges as input data of decision layer including: (1) collision-free rule among solitary wave: parallel or no cross point between solitary wave paths, (2) collision-free rule among solitary wave and fluctuation: whole solitary wave path is within upstream of fluctuation, (3) biggest solitary wave priority under collision among solitary waves, (4) solitary wave priority under collision between solitary wave and fluctuation, (5) solitary wave management: divide the intersections of a solitary wave path into groups, n^{LimS} intersections each group, make I-instructions that configure solitary wave path, SW-path-ban, re-SW-path, SW-time, and sends out the I-instructions.

14. A traffic signal Pan-String control system, includes a running A-A method predicting and controlling software, named as A-A package, a vehicle-positioning data center, or/and vehicle queues and their staying number detector, traffic signal controller, or/and vehicle entrance-exit detector of road-side vehicle source, or vehicle exit detector of an intersection, or/and vehicle entrance detector of a road-segment,
said A-A package predicts traffic, decides signal time scheme in next time interval according to vehicles' positions from vehicle-positioning data center or/and vehicle queue, staying vehicles from vehicles' queue detectors of intersections, or/and in/out-vehicles from road-side vehicles' sources, which is centered or distributed or paralleled and implemented with software or/and hardware,
said vehicle-positioning data center collects and stores last vehicle positions of the queues in every phase apart from local intersection as queues' lengths, which data are from vehicles positioning equipment, mobile phone's positioning/navigation device binding to vehicle, or any device that is equipped with a positioning device;
said vehicle queues detector is any device that detects phase vehicle queue length, the position of last vehicles of a phase queue, such as video analysis device, ultrasonic, microwave, infra-red, coils etc;
said vehicle in/out detector of road-side vehicle source detects vehicles entrance to and exit from a vehicle source at a road-segment side, such as parking-meters at road-side, detectors at gates of parking lot, alleys without signals, entrance/exit-vehicles of highways, or any business/residential area with parking lot capability, multiple vehicle sources at a road-side may be combined into one source according to average distance from local intersection of them to make an estimate of their in/out-vehicles total;
said vehicle exit detector detects out-vehicles from intersection, gates of parking lot, alleys without signals, entrance/exit-vehicles of highways, or any business/residential area with parking lot capability,
said vehicle entrance detector detects entrance vehicles to a road-segment, parking lot, alleys without signals, entrance/exit-vehicles of highways, or any business/residential area with parking lot capability said numbering vehicle detector includes coils, piezoelectricity, magnet-induct, infra-red, video or/and any device capable of numbering vehicles.

15. A system as defined in claim 14, wherein the system includes the steps of:
Said A-A package including modules called as intersection-neurons in predict layer that predicts vehicles of corresponding intersections in next time interval based on detected vehicles in this time interval, modules called as pre-judge-neurons in analysis layer that analyzes over-thresholds information based on over-thresholds of vehicles received from their intersection-neurons in predict layer, modules called as overall trade-off in decision layer that trades-off the pre-judges received from their pre-judge-neurons in the analysis layer.

16. A system as defined in claim 14, wherein the system includes the steps of:
Said intersection-neurons in predict layer of A-A package being related to a real intersection one to one, among them detected and predicted data are exchanged dynamically according to need.

17. A system as defined in claim 14, wherein the system includes the steps of:
Said intersection-neurons in predict layer of A-A package being input with phase vehicles queue in previous time interval, or/and out-vehicles of vehicles source of road-segment, their output are some predicted in next time interval remaining phase time, or/and out-vehicles, or/and vehicle queue change, or/and vehicles queue length, and their over-thresholds' information, send these information to corresponding pre-judge-neuron in analysis layer.

18. A system as defined in claim 14, wherein the system includes:
Said intersection-neurons in predict layer of A-A package including AI method module running the algorithms of neural network, statistical learning, or time series analysis.

19. A system as defined in claim 14, wherein the system includes:
Said pre-judge-neurons in analysis layer of A-A package being input with over-threshold related information from intersection-neuron, output signal time-offset or/and signals' temporary time-offset-table as pre-judges, to decision layer.

20. A system as defined in claim 14, wherein the system includes:
Said overall trade-off modules of decision layer of A-A package being input with pre-judges from analysis layer, output signal time instructions to executing layer, which trades-off choices, priority and schedule of these pre judges.
